(19) United States
(12) Patent Application Publication
(10) Pub. No.: US 2026/0369883 A1
(43) Pub. Date: Nov. 19, 2026

(54) V-BAND PHASED ARRAY ARCHITECTURE

(71) Applicant: CesiumAstro, Inc., Austin, TX (US)

(72) Inventors: Thomas Henry Hand, Highlands Ranch, CO (US); Angela Jachetti, Lafayette, CO (US); Cecile Masse, Irvine, CA (US); Biswadeep Das Gupta, Beaverton, OR (US); Greyson Beck, Denver, CO (US); Dongyin Ren, Austin, TX (US); Thomas Magesacher, Austin, TX (US)

(21) Appl. No.: 19/676,528

(22) Filed: May 13, 2026

Related U.S. Application Data
(60) Provisional application No. 63/805,116, filed on May 13, 2025.

(51) Int. Cl. H01Q 3/36; H01Q 1/02; H01Q 5/20; H01Q 21/06

(52) U.S. Cl. CPC H01Q 3/36; H01Q 1/02; H01Q 5/20; H01Q 21/061

(57) ABSTRACT

The present disclosure provides a high-frequency phased array antenna architecture configured for operation in V-band frequencies. The architecture includes a modular subarray structure comprising a plurality of beamforming slices integrated with radiating elements and radio frequency components within a compact form factor. Each beamforming slice includes amplification and phase control circuitry coupled to antenna elements through an interposer and a substrate integrated waveguide (SIW) to reduce losses and improve efficiency. A waveguide taper provides a transition to an enlarged radiating aperture to increase gain and reduce unwanted radiation effects. The architecture may further include thermal transport structures configured to dissipate heat associated with densely integrated components. The system supports scalable assembly into larger arrays capable of achieving high effective isotropic radiated power (EIRP) for a variety of radio frequency applications.

### CROSS-REFERENCE TO RELATED APPLICATIONS

This application claims the benefit of U.S. Provisional Patent Application No. 63/805,116 filed May 13, 2025, which is incorporated by reference herein in its entirety.

### TECHNICAL FIELD

The present disclosure generally relates to phased array antennas for radio frequency systems.

### BACKGROUND

Phased array antennas may manipulate the phase and amplitude of signals at individual elements of an array to generate a high-gain, directional beam that can be electronically steered without mechanical movement of the antenna. Such capabilities are particularly useful for communication and sensing systems operating at high radio frequencies. As spectrum congestion increases in lower frequency bands, higher frequency bands such as the V-band (e.g., approximately 40-75 GHz) present opportunities for high-capacity wireless communication and other radio frequency applications. However, operation in this frequency range presents several challenges. For example, available monolithic microwave integrated circuit (MMIC) components, such as amplifiers, phase shifters, and beamformers, are limited in availability and often exhibit relatively low output power and efficiency. In addition, signal propagation at V-band frequencies may be affected by atmospheric absorption, including oxygen absorption near approximately 60 GHz. As a result, certain applications, such as long-distance terrestrial links, may require increased system power and complexity. Other applications, including shorter-range terrestrial links and space-based links, may operate in portions of the V-band spectrum that exhibit lower atmospheric attenuation. Further, many currently available active devices operating at V-band frequencies provide limited output power and are designed for linear operation, resulting in relatively low efficiency, often below approximately 25% power added efficiency. Accordingly, achieving high effective isotropic radiated power (EIRP) typically requires a large number of active channels arranged in a dense array configuration. However, such dense integration introduces challenges associated with signal loss, parasitic effects, and thermal management, particularly in systems requiring compact size, weight, and power (SWaP).

### BRIEF DESCRIPTION OF THE DRAWINGS

Various embodiments in accordance with the present disclosure will be described with reference to the drawings, in which:

FIG. 1A illustrates a system for a modular phased array antenna architecture including a subarray comprising modular beamforming slices, backplane, antenna control unit, and thermal transport structures, according to example embodiments;

FIG. 1B illustrates a modular beamforming slice including a beamforming circuit, amplification and phase control components, a silicon carbide interposer, a substrate integrated waveguide (SIW), a waveguide taper, and a radiating element, according to example embodiments;

FIG. 1C illustrates system-level requirements for a V-band active electronically scanned array antenna system including operating frequency, output power, EIRP, scan volume, and polarization characteristics, according to example embodiments;

FIG. 2A illustrates a subarray including a plurality of modular beamforming slices and heat diffusion elements arranged within a housing and coupled to a backplane and antenna control unit, according to example embodiments;

FIG. 2B illustrates a system including a plurality of subarrays arranged in a two-dimensional array configuration to form a larger antenna aperture, according to example embodiments;

FIG. 2C illustrates a top-down view of a subarray including modular beamforming slices arranged in parallel with interleaved heat diffusion elements, according to example embodiments;

FIG. 2D illustrates a subarray including a two-dimensional grid of antenna elements arranged in a 16×16 configuration, according to example embodiments;

FIG. 2E illustrates a system including a plurality of subarrays arranged in a tiled configuration to form a larger phased array aperture, according to example embodiments;

FIG. 3A illustrates an exploded view of a subarray including modular beamforming slices, heat diffusion elements, a backplane, and an antenna control unit within a housing, according to example embodiments;

FIG. 3B illustrates a cross-sectional view of a system including stacked modular beamforming slices and adjacent heat diffusion elements, according to example embodiments;

FIG. 3C illustrates a modular beamforming slice including a beamforming circuit, driver amplifiers, power amplifiers, and structural features for dense integration, according to example embodiments;

FIG. 4 illustrates a modular beamforming slice configured to receive radio frequency inputs and distribute processed signals across a plurality of antenna elements via amplification and phase control stages, according to example embodiments;

FIG. 5 illustrates performance characteristics of a phased array antenna system including operating frequency, gain, directivity, and effective isotropic radiated power, according to example embodiments;

FIG. 6 illustrates a cross-sectional view of a vertically integrated structure including a die, interposer, vias, substrate integrated waveguide, and radiating element within a multilayer printed circuit board, according to example embodiments;

FIG. 7 illustrates a multilayer printed circuit board structure including dielectric layers, conductive layers, and via structures configured for radio frequency routing and vertical interconnection, according to example embodiments;

FIG. 8 illustrates a system for characterizing power consumption and power dissipation at subarray and array levels for a phased array architecture, according to example embodiments; and

FIG. 9 illustrates a process for generating a directional beam including signal splitting, phase and amplitude control, amplification, routing through an interposer and SIW, and radiation by antenna elements, according to example embodiments.

### DETAILED DESCRIPTION

The present disclosure provides a phased array antenna architecture configured for operation at V-band frequencies (e.g., approximately 70-75 GHz). The architecture addresses limitations associated with conventional high-frequency arrays, including limited component availability, high path loss, and thermal constraints arising from dense element packing. In contrast to systems that rely on discrete antenna structures and lossy interconnects, the disclosed architecture employs a modular subarray design in which radiating elements and active radio frequency components are co-integrated within a compact structure. This approach enables highly effective isotropic radiated power (EIRP), for example on the order of 75 dBW, while maintaining scalability for applications such as space-based communication systems. The architecture may be implemented in various configurations, including direct radiating arrays and phased array-fed reflector systems. The disclosure further provides structural features that improve efficiency, reduce losses, and enhance thermal management. In at least one embodiment, antenna elements are implemented as substrate integrated waveguide (SIW) structures embedded within a printed circuit board, enabling direct integration with beamforming and amplification components while reducing parasitic losses. Each antenna element may include a stepped waveguide taper configured to increase gain and suppress grating lobes by transitioning to an electrically larger aperture. The architecture may also include one or more thermal transport structures, such as heat pipes, configured to remove heat from densely packed active components. In addition, a silicon carbide interposer may provide direct coupling between a power amplifier and a corresponding SIW structure, reducing transition losses and improving overall efficiency. Collectively, these features provide an integrated solution that addresses both electromagnetic and thermal limitations of conventional high-frequency phased array systems.

Embodiments of an antenna system, as well as methods of building and operating such a system, are described herein. In at least one embodiment, the system includes a modular, scalable, subarray-based V-band architecture (e.g., 60-75 GHz with approximately 5 GHz operating bandwidth) capable of supporting single-beam or multi-beam (e.g., two or more beams) operation. The architecture may be configured for a variety of use cases, including medium Earth orbit (MEO) missions (e.g., approximately ±20° scan). In some implementations, the system can achieve a boresight EIRP of 60 dBW (90 dBm) or higher. The architecture may also be configurable as a direct radiating array (DRA) or a phased array-fed reflector (PAFR), among other configurations. In at least one embodiment, antenna elements are implemented using SIW structures formed within a printed circuit board (PCB) that hosts beamforming integrated circuits, driver amplifiers, and power amplifiers. This integration reduces losses and parasitics associated with interconnection to separate antenna structures. In some embodiments, each antenna element includes a stepped waveguide taper to increase gain. For example, a TE₀₁ mode waveguide may transition to a larger aperture (e.g., approximately one wavelength, λ), which can suppress grating lobes and improve radiation characteristics. The system may be configured such that the mechanical housing also facilitates heat transfer to a heatsink. For example, one or more thermal transport structures may be used to remove thermal energy from beamforming components. Active devices may be mounted, for example, as flip-chip dies to improve thermal conduction. In addition, the housing and associated thermal interface materials may be designed to provide high thermal conductivity while also confining electromagnetic fields, enabling sufficient channel-to-channel and reverse isolation and supporting stable amplifier operation across the operating band.

In at least one embodiment, a silicon carbide (SiC) interposer provides a direct transition into a SIW with a direct feed to the antenna element. This approach enables a low-loss connection from a final-stage power amplifier into the SIW, reducing transition losses and improving overall efficiency and EIRP. Such an implementation may also support fan-out of MMIC input/output connections using standard printed circuit board fabrication processes. In some embodiments, subarrays may be configured as feeds for phased array-fed reflector (PAFR) systems. A subarray may include, for example, multiple beamforming slices (e.g., sixteen slices) with a total of 256 radiating elements. Increasing the number of elements in one direction may facilitate integration of components such as an antenna control unit (ACU) within the subarray.

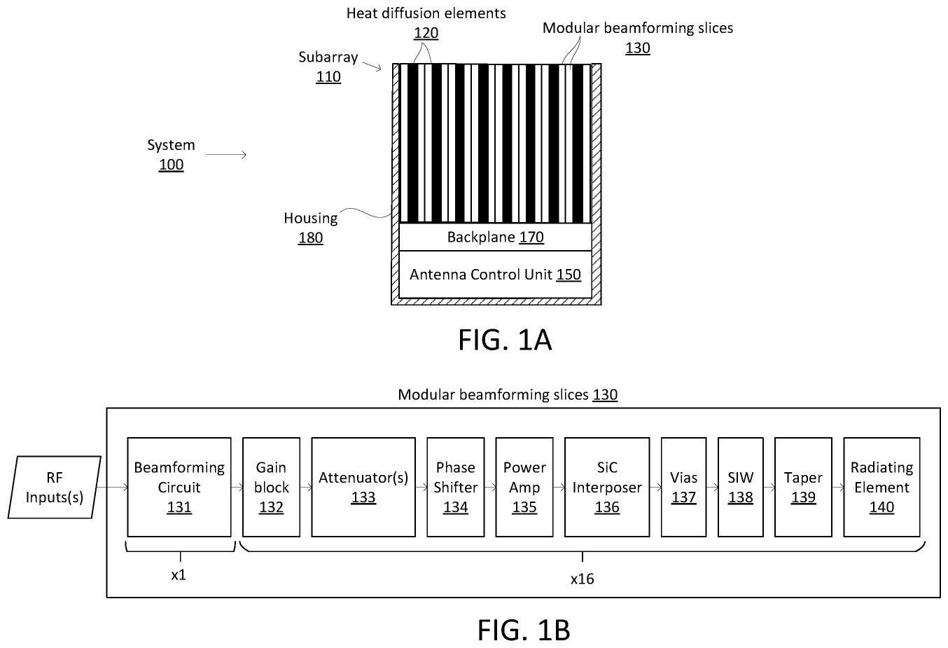

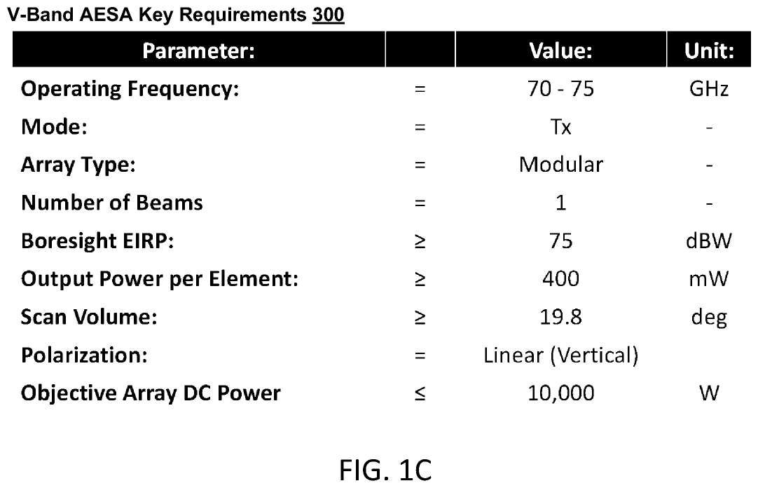

FIG. 1A illustrates a system 100 for providing a modular phased array antenna architecture configured to generate a high-gain directional beam. The system 100 may include a subarray 110 comprising a plurality of modular beamforming slices 130, each modular beamforming slice 130 including a plurality of antenna elements and associated radio frequency components configured to generate and radiate radio frequency signals. The modular beamforming slices 130 may be arranged in a stacked or tiled configuration within a housing 180, such that a high density of antenna elements may be achieved within a compact form factor. In example embodiments, the modular beamforming slices 130 may be electrically coupled to a backplane 170, the backplane 170 being configured to distribute power, control signals, and radio frequency signals among the modular beamforming slices 130. The system 100 may further include an antenna control unit 150 coupled to the backplane 170, the antenna control unit 150 being configured to provide control signals for beamforming operations, including phase and amplitude adjustments across the plurality of antenna elements.

The system 100 may further include a plurality of heat diffusion elements 120 disposed adjacent to or integrated with the modular beamforming slices 130, the plurality of heat diffusion elements 120 being configured to transfer thermal energy away from active components within the modular beamforming slices 130. The plurality of heat diffusion elements 120 may include one or more heat pipes or similar thermal transport structures configured to remove heat from high power density regions within the subarray 110. The housing 180 may be configured to provide mechanical support and additional thermal conduction paths, such that heat generated by the modular beamforming slices 130 may be dissipated efficiently. In example embodiments, the modular beamforming slices 130 may include substrate integrated waveguide structures, waveguide tapers, and interposer-based coupling structures to provide efficient signal transmission from amplification components to radiating elements, although such structures may not be explicitly illustrated in FIG. 1A.

The system 100 may operate such that the antenna control unit 150 provides control signals to the modular beamforming slices 130 via the backplane 170, the modular beamforming slices 130 generating a plurality of phase-controlled radio frequency signals that are radiated by the plurality of antenna elements to form a directional beam. As a nonlimiting example, the system 100 may be deployed in a satellite communication system in which the subarray 110 generates a high-gain beam toward another satellite or a ground station, while the plurality of heat diffusion elements 120 may transfer heat generated by the modular beamforming slices 130 away from the subarray 110 to maintain reliable operation under high power conditions. In other example embodiments, the system 100 may be configured for alternative applications or operating conditions, and additional or alternative components may be included without departing from the scope of the present disclosure.

FIG. 1B illustrates a modular beamforming slice 130 configured to receive one or more radio frequency inputs and generate a plurality of phase-controlled output signals that are radiated by a corresponding plurality of antenna elements. The modular beamforming slice 130 may include a beamforming circuit 131, a gain block 132, one or more attenuators 133, a phase shifter 134, a power amplifier 135, a silicon carbide interposer 136, one or more vias 137, an SIW 138, a waveguide taper 139, and a radiating element 140. The beamforming circuit 131 may receive one or more radio frequency inputs and may generate a plurality of output signals, each output signal corresponding to a respective signal path within the modular beamforming slice 130. In example embodiments, the beamforming circuit 131 may adjust one or more signal parameters, such as phase and amplitude, for each of the plurality of output signals to support beam steering functionality.

In example embodiments, each signal path downstream of the beamforming circuit 131 may include the gain block 132, the one or more attenuators 133, the phase shifter 134, and the power amplifier 135, arranged in series. The gain block 132 may amplify the signal provided by the beamforming circuit 131, and the one or more attenuators 133 may adjust a signal amplitude in a controllable manner. The phase shifter 134 may modify a phase of the signal to achieve a desired phase relationship across the plurality of signal paths, and the power amplifier 135 may further amplify the signal to a level suitable for radiation by the radiating element 140. In example embodiments, the modular beamforming slice 130 may include a plurality of such signal paths, the plurality of signal paths corresponding to the plurality of radiating elements 140, such that the modular beamforming slice 130 may support parallel generation of multiple phase-controlled signals.

The output of the power amplifier 135 in each signal path may be coupled to the SIW 138 through the silicon carbide interposer 136 and the one or more vias 137. The silicon carbide interposer 136 may provide a low-loss transition between the power amplifier 135 and the SIW 138, while enabling integration of active components with a printed circuit board architecture. The one or more vias 137 may provide a vertical electrical connection from the silicon carbide interposer 136 to the SIW 138, the SIW 138 being formed within one or more dielectric layers of the printed circuit board. The SIW 138 may propagate the radio frequency signal toward the radiating element 140 with reduced loss and improved confinement relative to conventional transmission line structures.

The SIW 138 may transition to the radiating element 140 through the waveguide taper 139, the waveguide taper 139 being configured to increase an effective aperture size and improve radiation efficiency. The waveguide taper 139 may include a stepped transition that gradually expands the SIW 138 to a larger radiating aperture associated with the radiating element 140. The radiating element 140 may be configured as a single-polarization antenna element and may radiate the signal into free space as part of a directional beam generated by the modular beamforming slice 130. As a nonlimiting example, when a plurality of the signal paths are operated with controlled phase differences, the plurality of radiating elements 140 may collectively generate and steer a high-gain beam in a selected direction.

The modular beamforming slice 130 may operate as part of a larger phased array system, as described with respect to FIG. 1A, wherein multiple modular beamforming slices 130 may be arranged to form a subarray. As a nonlimiting example, the modular beamforming slice 130 may be utilized in a V-band satellite communication system in which the beamforming circuit 131 may dynamically adjust phase and amplitude across the plurality of signal paths to direct a communication beam toward another satellite or a ground station, while the integration of the silicon carbide interposer 136, the vias 137, and the SIW 138 may improve efficiency and reduce losses in high-frequency operation. In other example embodiments, variations in the ordering, inclusion, or configuration of the gain block 132, the one or more attenuators 133, the phase shifter 134, and the power amplifier 135 may be implemented without departing from the scope of the present disclosure.

FIG. 1C illustrates a set of system-level requirements 300 for a V-band active electronically scanned array (AESA) antenna system. The requirements 300 may define operating parameters that guide the design and implementation of the phased array architecture described herein. In example embodiments, the requirements 300 may include an operating frequency range corresponding to V-band frequencies, for example between approximately 70 GHz and 75 GHz, and may specify a transmit mode of operation. The requirements 300 may further indicate that the antenna system may be implemented as a modular array architecture, such as a plurality of subarrays comprising modular beamforming slices, as described with respect to FIGS. 1A and 1B. In example embodiments, the requirements 300 may also include a specified number of beams, such as a single beam configuration, and a target effective isotropic radiated power (EIRP), for example greater than or equal to approximately 75 dBW.

The requirements 300 may be used to inform the selection and configuration of system components described throughout the present disclosure, including the modular beamforming slice 130, the substrate integrated waveguide (SIW) structures, the waveguide taper structures, and the thermal transport structures such as heat pipes. The requirements 300 may also influence design trade-offs between performance, efficiency, and thermal management, particularly in view of the high power density associated with V-band operation. As a nonlimiting example, a system designed to meet the requirements 300 may be deployed in a satellite communication system in which a high-gain directional beam may be generated for communication between satellites or between a satellite and a ground station. In other example embodiments, the requirements 300 may vary depending on application constraints, and additional or alternative requirements 300 may be used without departing from the scope of the present disclosure.

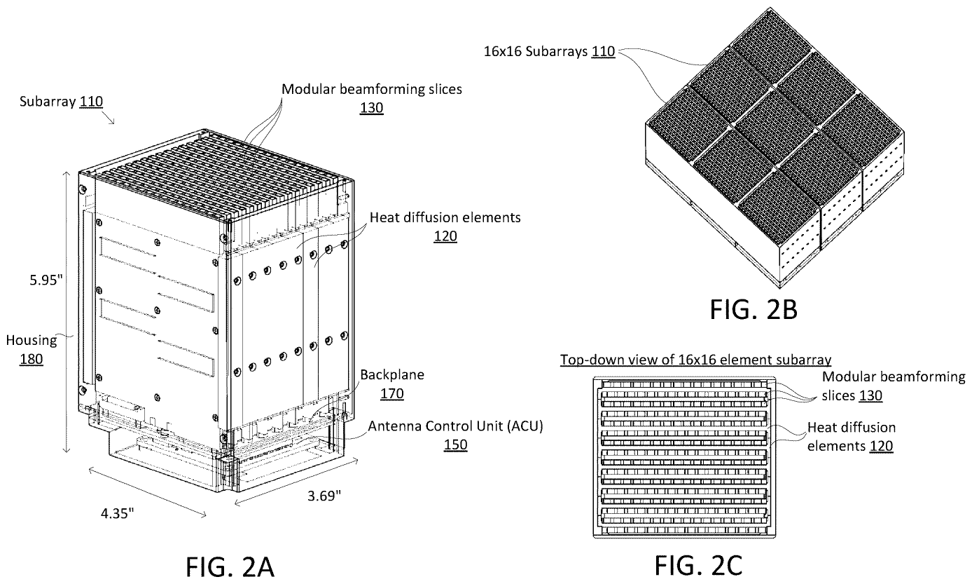

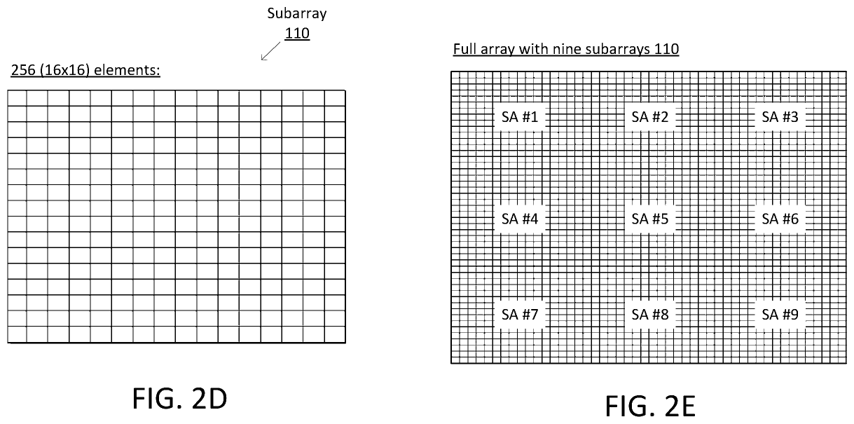

FIG. 2A illustrates a subarray 110 comprising a plurality of modular beamforming slices 130 arranged within a housing 180. The subarray 110 may include a stacked or tiled arrangement of the modular beamforming slices 130, each modular beamforming slice 130 including a plurality of antenna elements and associated radio frequency components configured to generate and radiate radio frequency signals, as described with respect to FIG. 1B. In example embodiments, the modular beamforming slices 130 may be arranged with a high packing density in a planar configuration, such that a large number of antenna elements may be provided within a compact aperture. The subarray 110 may have dimensions on the order of several inches, as illustrated, although other sizes and form factors may be used in other example embodiments depending on application requirements.

The system may further include a plurality of heat diffusion elements 120 disposed adjacent to the modular beamforming slices 130 and extending along one or more sides of the subarray 110. The plurality of heat diffusion elements 120 may comprise one or more thermal transport structures, such as heat pipes, configured to remove thermal energy generated by active components within the modular beamforming slices 130. The heat diffusion elements 120 may be thermally coupled to the modular beamforming slices 130 such that heat generated by power amplifiers, driver amplifiers, and beamforming circuitry may be conducted outward and dissipated, thereby supporting operation at high power density. In example embodiments, the arrangement of the plurality of heat diffusion elements 120 and the modular beamforming slices 130 may be selected to provide efficient thermal paths while maintaining electrical isolation and structural integrity.

The modular beamforming slices 130 and the plurality of heat diffusion elements 120 may be supported by the housing 180, the housing 180 providing mechanical support and additional thermal conduction paths. The system may further include a backplane 170 disposed within the housing 180 and electrically coupled to the plurality of modular beamforming slices 130. The backplane 170 may be configured to distribute power, control signals, and radio frequency signals to and from the modular beamforming slices 130. An antenna control unit (ACU) 150 may be coupled to the backplane 170 and configured to provide control signals for beamforming operations, including phase and amplitude control for the plurality of antenna elements. In example embodiments, the backplane 170 and the antenna control unit 150 may be integrated within a lower portion of the housing 180, as illustrated, although other arrangements may be used in other example embodiments.

The system may operate such that the antenna control unit 150 provides control signals to the plurality of modular beamforming slices 130 via the backplane 170, and each modular beamforming slice 130 may generate a plurality of radio frequency signals that are radiated by corresponding antenna elements to form a directional beam. The high-density arrangement of the modular beamforming slices 130 may allow the subarray 110 to achieve a high effective isotropic radiated power while maintaining a compact form factor. As a nonlimiting example, the system may be deployed in a satellite communication system in which the subarray 110 may be used to generate a high-gain communication beam for a space-to-space or space-to-ground link at V-band frequencies. In other example embodiments, the system may be used in other communication systems or sensing applications, and additional or alternative components and configurations may be employed without departing from the scope of the present disclosure.

FIG. 2B illustrates a plurality of subarrays 110 arranged in a two-dimensional array configuration to form a larger antenna aperture. The plurality of subarrays 110 may each include a corresponding set of modular beamforming slices 130 and associated antenna elements, as described with respect to FIGS. 1A and 1B. In example embodiments, the plurality of subarrays 110 may be arranged in a grid or tiled configuration, for example a 3×3 arrangement as illustrated, such that the combined aperture of the plurality of subarrays 110 may produce a higher overall gain relative to a single subarray. The plurality of subarrays 110 may be positioned adjacent to one another within a common housing or mounting structure, although other arrangements may be used in other example embodiments.

Each subarray 110 within the system may operate in coordination with the other subarrays 110 to generate a composite directional beam. For example, each subarray 110 may generate a subarray-level beam based on phase and amplitude control provided by an associated antenna control unit 150, and the plurality of subarrays 110 may be further controlled to align the respective subarray-level beams to form a coherent overall beam. In this manner, the system may achieve a higher effective isotropic radiated power (EIRP) and improved directivity compared to operation of a single subarray 110. In example embodiments, the coordination among the plurality of subarrays 110 may be achieved through centralized or distributed control architectures, including control signals communicated through one or more backplanes or interconnect structures.

As a nonlimiting example, the system may be implemented in a satellite communication system in which the plurality of subarrays 110 forms a large aperture phased array antenna used to establish a high-capacity communication link between satellites or between a satellite and a ground station at V-band frequencies. In other example embodiments, the system may be implemented in alternative communication or sensing systems, and the number, arrangement, and configuration of the plurality of subarrays 110 may vary depending on system requirements without departing from the scope of the present disclosure.

FIG. 2C illustrates a top-down view of a subarray 110 including a plurality of modular beamforming slices 130 and a plurality of heat diffusion elements 120. The subarray 110 may include a plurality of the modular beamforming slices 130 arranged in a parallel, elongated configuration, each modular beamforming slice 130 extending across a dimension of the subarray 110. In example embodiments, each modular beamforming slice 130 may include a plurality of antenna elements distributed along a length of the modular beamforming slice 130, such that the subarray 110 forms a two-dimensional array of antenna elements when viewed from above. The modular beamforming slices 130 may be arranged with a consistent spacing or pitch, enabling uniform element distribution and consistent beamforming performance across the subarray 110.

In example embodiments, the plurality of heat diffusion elements 120 may be interleaved with, or arranged adjacent to, the plurality of modular beamforming slices 130. The plurality of heat diffusion elements 120 may extend along a length of the modular beamforming slices 130, providing thermal transport paths that may remove heat generated by active components within the modular beamforming slices 130. The arrangement illustrated in FIG. 2C may enable efficient thermal management by distributing heat removal structures across the subarray 110, thereby reducing localized thermal buildup and supporting high power density operation. In example embodiments, the plurality of heat diffusion elements 120 may comprise heat pipes or other thermal transport devices configured to transfer thermal energy to a housing or external heatsink.

FIG. 2D illustrates a subarray 110 including a plurality of antenna elements arranged in a two-dimensional grid, in example embodiments. The subarray 110 may include a total of 256 antenna elements arranged in a 16×16 configuration, as illustrated. Each of the antenna elements may be associated with a corresponding signal path within one or more modular beamforming slices 130, as described with respect to FIG. 1B, and may be configured to radiate radio frequency energy as part of a coherent beam. In example embodiments, the arrangement of the plurality of antenna elements within the subarray 110 may be selected based on a desired element spacing relative to an operating wavelength, such as a spacing corresponding to a fraction of a wavelength at V-band frequencies. The element spacing may influence beamforming performance parameters including sidelobe levels, scan volume, and overall gain.

FIG. 2E illustrates a plurality of subarrays 110 arranged to form a larger array aperture, in example embodiments. The plurality of subarrays 110 may include, as illustrated, nine subarrays arranged in a 3×3 grid, each subarray 110 corresponding to a configuration such as that described with respect to FIG. 2D. The plurality of subarrays 110 may be arranged adjacent to one another such that the antenna elements of the respective subarrays 110 collectively form a larger two-dimensional lattice of antenna elements. In example embodiments, each subarray 110 may be independently controlled, for example by a corresponding antenna control unit 150, or may be controlled in a coordinated manner to produce a composite beam across the full aperture.

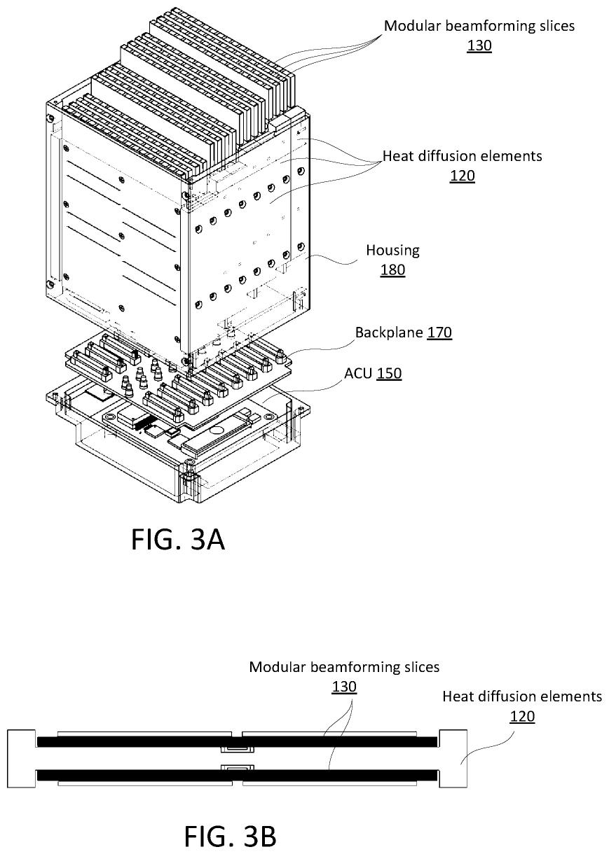

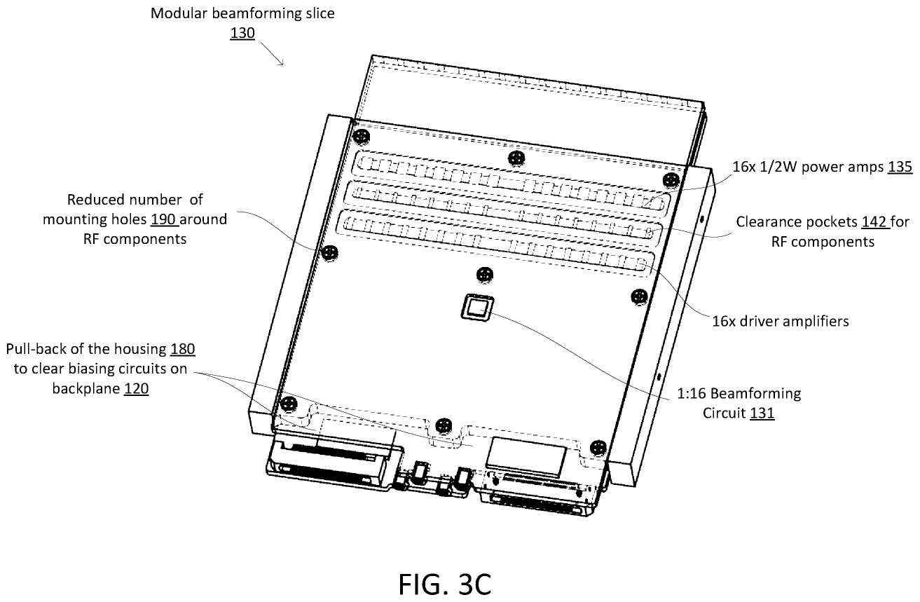

FIG. 3A illustrates a subarray 110 and associated support structures in an exploded configuration. The system may include a plurality of modular beamforming slices 130 arranged within an upper portion of the system, the modular beamforming slices 130 being configured to generate and radiate radio frequency signals, as described with respect to FIG. 1B. The system may further include a plurality of heat diffusion elements 120 disposed adjacent to the modular beamforming slices 130, the plurality of heat diffusion elements 120 being configured to remove thermal energy generated by active radio frequency components within the modular beamforming slices 130. In example embodiments, the exploded view may illustrate how the modular beamforming slices 130, the plurality of heat diffusion elements 120, and other system components may be assembled within a housing 180 to form a compact, high-density phased array structure.

The system may include a backplane 170 disposed below the modular beamforming slices 130, the backplane 170 being configured to distribute power, control signals, and radio frequency signals to and from the modular beamforming slices 130. The system may further include an antenna control unit (ACU) 150 disposed below the backplane 170, the antenna control unit 150 being configured to provide beamforming control signals to the modular beamforming slices 130. The exploded configuration illustrated in FIG. 3A may demonstrate how electrical connections may be established between the antenna control unit 150 and the modular beamforming slices 130 through the backplane 170. In example embodiments, the backplane 170 may include connectors, conductive traces, or other structures configured to electrically couple the antenna control unit 150 to the modular beamforming slices 130.

Each modular beamforming slice 130 may include a plurality of antenna elements and associated radio frequency signal paths including amplification components, phase control elements, and feed structures such as silicon carbide interposers, vias, and substrate integrated waveguides, although such elements may not be explicitly illustrated in FIG. 3A. The plurality of heat diffusion elements 120 may be thermally coupled to regions of the modular beamforming slices 130 that include power amplifiers or other high power density components, such that heat may be conducted away from the modular beamforming slices 130 and dissipated through the housing 180 or other thermal interfaces. The exploded arrangement may illustrate that the thermal transport structure may be integrated with the mechanical assembly of the system to provide both structural support and thermal management.

The system may operate such that the antenna control unit 150 provides control signals to the modular beamforming slices 130 via the backplane 170, the modular beamforming slices 130 generating a plurality of phase-controlled radio frequency signals that are radiated by corresponding antenna elements to form a directional beam. As a nonlimiting example, the system may be deployed in a satellite communication system in which the modular beamforming slices 130 are assembled into the housing 180, and the plurality of heat diffusion elements 120 may remove heat generated during high-power transmission at V-band frequencies. In other example embodiments, the arrangement of the modular beamforming slices 130, the plurality of heat diffusion elements 120, the backplane 170, and the antenna control unit 150 may vary depending on system requirements, and additional or alternative components may be included without departing from the scope of the present disclosure.

FIG. 3B illustrates a perspective view of a plurality of modular beamforming slices 130 and a plurality of heat diffusion elements 120. The modular beamforming slices 130 may be arranged in a stacked configuration within a mechanical support structure, such that a high density of antenna elements and associated radio frequency components may be achieved within a compact volume. In example embodiments, the modular beamforming slices 130 may include internal signal paths comprising amplification components, interposer structures, vias, SIWs, waveguide tapers, and radiating elements, as described with respect to FIG. 1B, although such internal structures may not be explicitly illustrated in FIG. 3B. The cross-sectional view illustrated in FIG. 3B may emphasize the relative positioning of the modular beamforming slices 130 with respect to the plurality of heat diffusion elements 120 and supporting structures.

In example embodiments, the plurality of heat diffusion elements 120 may be positioned adjacent to the modular beamforming slices 130 and may extend along one or more surfaces of the modular beamforming slices 130. The plurality of heat diffusion elements 120 may comprise one or more thermal transport structures, such as heat pipes, configured to remove thermal energy generated by high power density components within the modular beamforming slices 130. As a nonlimiting example, thermal energy generated by power amplifiers and driver amplifiers within the modular beamforming slices 130 may be conducted to the plurality of heat diffusion elements 120 and transported away from the modular beamforming slices 130 to maintain desired operating temperatures. In example embodiments, the arrangement illustrated in FIG. 3B may provide a direct thermal path between the modular beamforming slices 130 and the plurality of heat diffusion elements 120, thereby reducing thermal resistance and improving overall system reliability.

FIG. 3C illustrates a modular beamforming slice 130 configured to support dense integration of radio frequency components within a compact mechanical structure. The modular beamforming slice 130 may include a beamforming circuit 131, a plurality of driver amplifiers, and a plurality of power amplifiers 135 arranged to support multiple parallel signal paths, as described with respect to FIG. 1B. In example embodiments, the beamforming circuit 131 may include a multi-channel beamformer integrated circuit configured to receive radio frequency input signals and generate a plurality of phase-controlled output signals. The plurality of driver amplifiers may be configured to amplify the output signals from the beamforming circuit 131 prior to further amplification by the plurality of power amplifiers 135. The plurality of power amplifiers 135, which may include, as a nonlimiting example, sixteen power amplifiers corresponding to sixteen antenna elements, may be arranged along a portion of the modular beamforming slice 130 to provide high-power output signals for radiation.

In example embodiments, the modular beamforming slice 130 may further include structural features configured to accommodate the dense placement of radio frequency components and to support mechanical integration with adjacent systems. For example, the modular beamforming slice 130 may include one or more clearance pockets 142 configured to provide space for radio frequency components, such as amplifiers and associated circuitry, thereby reducing mechanical interference and enabling compact packaging. The modular beamforming slice 130 may also include a reduced number of mounting holes 190 in regions corresponding to high-density radio frequency components, which may enable improved routing of signals and reduced disruption of the electromagnetic environment within the slice. In example embodiments, the housing 180 may be shaped with a pull-back region configured to clear biasing circuits on the backplane 170, thereby allowing the modular beamforming slice 130 to be positioned closer to other components while maintaining electrical isolation and proper biasing connections.

As a nonlimiting example, the modular beamforming slice 130 illustrated in FIG. 3C may be implemented in a satellite communication system in which high-density integration of beamforming, amplification, and antenna feed structures enables generation of a high-gain directional beam. The structural features, including the plurality of power amplifiers 135, the plurality of driver amplifiers, the clearance pockets 142, and the configuration of the housing 180, may enable the system to operate under high power density conditions while maintaining mechanical integrity and thermal performance.

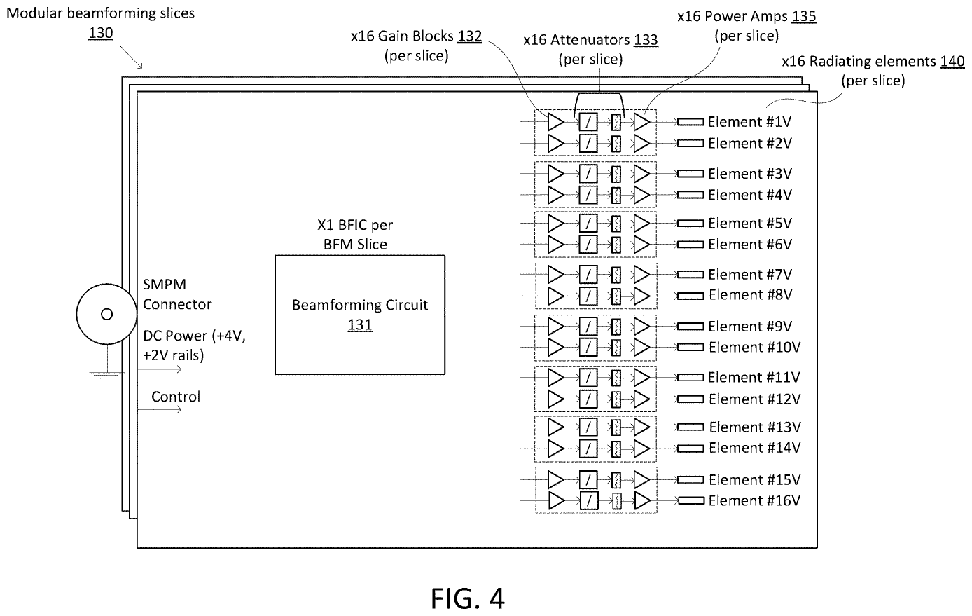

FIG. 4 illustrates a modular beamforming slice 130 configured to process radio frequency signals and distribute the radio frequency signals across a plurality of antenna elements, in example embodiments. The modular beamforming slice 130 may include a beamforming circuit 131 coupled to a connector, such as an SMPM connector, configured to receive one or more radio frequency inputs, as well as direct current (DC) power and control signals. The beamforming circuit 131 may generate a plurality of output signals corresponding to a plurality of signal paths, each signal path being associated with a respective radiating element 140. In example embodiments, the beamforming circuit 131 may adjust phase and amplitude of each signal path to support beam steering operations across the plurality of antenna elements.

Each of the plurality of signal paths may include a gain block 132, one or more attenuators 133, a phase shifter 134, and a power amplifier 135 arranged in sequence. The gain block 132 may amplify a signal from the beamforming circuit 131, and the one or more attenuators 133 may provide controllable attenuation of the signal amplitude. The phase shifter 134 may adjust a phase of the signal to achieve a desired phase distribution across the plurality of radiating elements 140, and the power amplifier 135 may amplify the signal to a power level suitable for radiation. In example embodiments, the modular beamforming slice 130 may include sixteen instances of the gain block 132, the one or more attenuators 133, the phase shifter 134, and the power amplifier 135, corresponding to sixteen radiating elements 140, although other quantities of signal paths may be used in other example embodiments.

Each of the plurality of radiating elements 140 may include a feed structure comprising a silicon carbide interposer, one or more vias, a substrate integrated waveguide (SIW), and a waveguide taper, as described with respect to FIG. 1B. Although the silicon carbide interposer, the one or more vias, the SIW, and the waveguide taper may not be explicitly illustrated in FIG. 4, each radiating element 140 may include such structures configured to convey radio frequency signals from the corresponding power amplifier 135 to a radiating aperture. The SIW may provide a low-loss transmission path within a printed circuit board, and the waveguide taper may provide a transition to an electrically larger aperture to improve radiation efficiency and gain.

The modular beamforming slice 130 may operate such that the beamforming circuit 131 receives a radio frequency input signal through the connector and generates a plurality of phase-controlled signals, each signal being amplified and processed by the corresponding gain block 132, the one or more attenuators 133, the phase shifter 134, and the power amplifier 135, and subsequently radiated by the plurality of radiating elements 140. As a nonlimiting example, the modular beamforming slice 130 may be deployed in a satellite communication system in which the plurality of radiating elements 140 may be controlled to form and steer a directional beam toward another satellite or a ground station. In other example embodiments, the arrangement and ordering of the gain block 132, the one or more attenuators 133, the phase shifter 134, and the power amplifier 135 may vary, and additional signal conditioning components may be included without departing from the scope of the present disclosure.

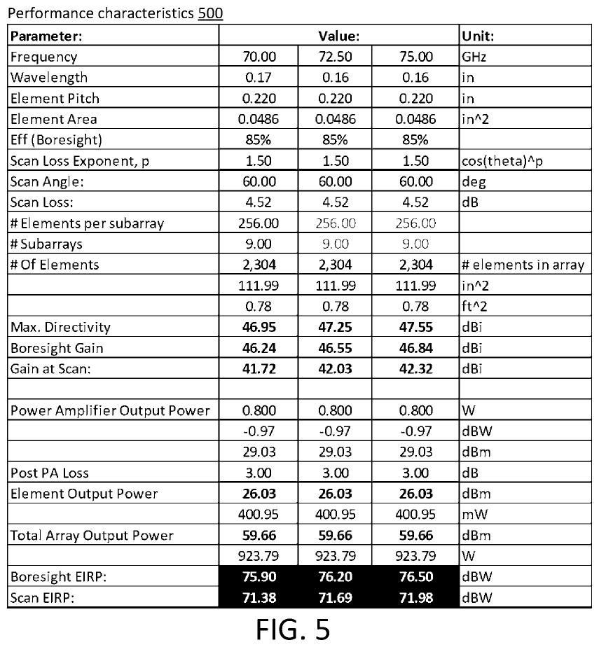

FIG. 5 illustrates a set of performance characteristics 500 associated with a phased array antenna system. The performance characteristics 500 may include operating frequency ranges, antenna element parameters, array configuration parameters, and resulting system-level metrics such as gain, directivity, and effective isotropic radiated power (EIRP). In example embodiments, the performance characteristics 500 may correspond to operation across a V-band frequency range, such as approximately 70 GHz to 75 GHz, and may reflect design choices associated with antenna element spacing, wavelength, and array size. The performance characteristics 500 may further include parameters associated with scan performance, such as scan angle and scan loss, which may influence overall antenna efficiency and directional beam formation.

In example embodiments, the performance characteristics 500 may illustrate how individual antenna element output power, amplification losses, and array size combine to produce overall system-level performance, including total array output power and EIRP. The plurality of antenna elements, which may be arranged into one or more subarrays and further combined into a larger array as described with respect to FIGS. 2D and 2E, may collectively contribute to beamforming gain and directivity. As a nonlimiting example, a phased array antenna system configured in accordance with the performance characteristics 500 may be deployed in a satellite communication system in which a high-gain beam may be generated to support communication between satellites or between a satellite and a ground station. In other example embodiments, the specific values and relationships illustrated in FIG. 5 may vary based on system requirements, and alternative configurations may be used without departing from the scope of the present disclosure.

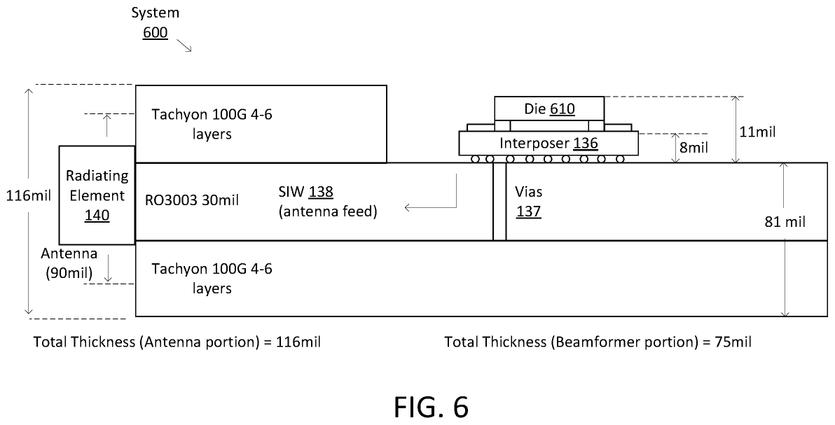

FIG. 6 illustrates a cross-sectional view of a system 600 showing a vertical integration of radio frequency components, an SIW structure, and a radiating element within a multi-layer printed circuit board, in example embodiments. The system 600 may include a die 610 mounted above an interposer 136, the interposer 136 being electrically coupled to one or more vias 137 that extend vertically through a plurality of dielectric layers. The vias 137 may provide an electrical transition from the die 610, through the interposer 136, to an SIW 138 formed within one or more internal layers of the printed circuit board. The SIW 138 may extend laterally within a dielectric layer (e.g., a RO3003 material layer) and may function as a low-loss transmission path for radio frequency signals. In example embodiments, the SIW 138 may serve as an antenna feed structure, conveying signals from active radio frequency components to a radiating element 140 positioned at an opposite end of the structure.

In example embodiments, the system 600 may further illustrate a transition from the SIW 138 to the radiating element 140, which may include a waveguide taper configured to expand an effective aperture size to improve radiation efficiency and antenna gain. Although the waveguide taper may not be explicitly labeled, the radiating element 140 may include such a tapered structure within a portion of the antenna region. The printed circuit board may include multiple dielectric layers, such as Tachyon 100G layers and a core material, with different thicknesses corresponding to an antenna portion and a beamformer portion. For example, the antenna portion may have a greater thickness relative to the beamformer portion to support the radiating structure, while the beamformer portion may provide a compact region for integrating active components such as the die 610.

As a nonlimiting example, the system 600 may operate such that a radio frequency signal generated by the die 610 may be transmitted through the interposer 136 and the one or more vias 137 into the SIW 138, which may guide the signal toward the radiating element 140. The radiating element 140 may then emit the signal into free space as part of a directional beam generated by a phased array system. The use of the SIW 138, the interposer 136, and the via transition may reduce losses associated with conventional interconnects and may enable dense integration of active and passive components within a compact footprint. In other example embodiments, variations in material selection, layer thickness, or geometric configuration may be used without departing from the scope of the present disclosure.

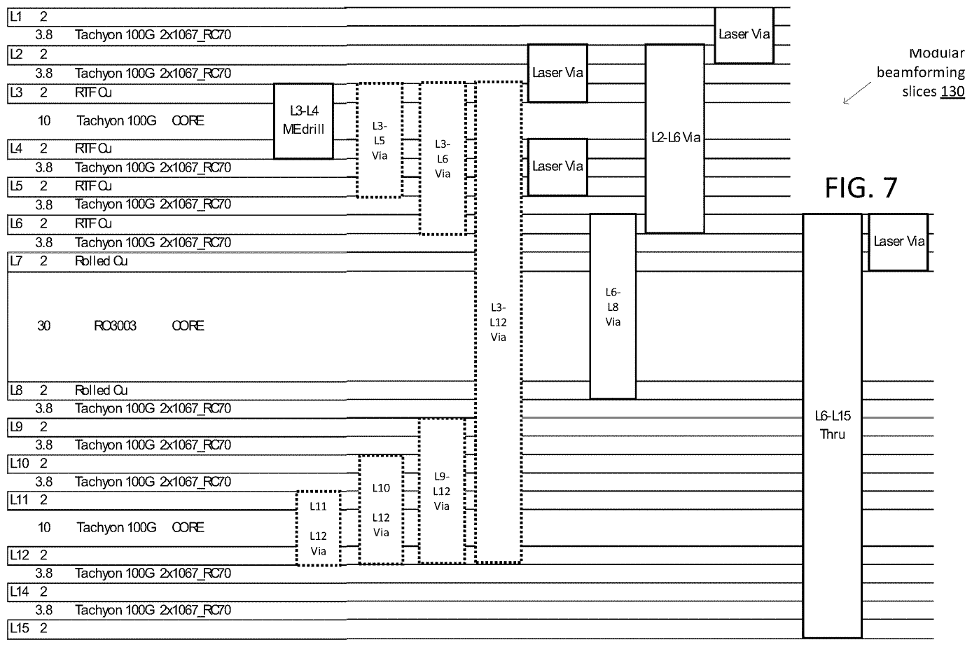

FIG. 7 illustrates a cross-sectional view of a multilayer printed circuit board structure included in a portion of the modular beamforming slices 130, the multilayer printed circuit board structure being configured to support vertical electrical interconnections and radio frequency signal routing within the modular beamforming slices 130. The multilayer printed circuit board structure may include a plurality of dielectric layers, such as a set of Tachyon 100G dielectric layers disposed across multiple levels L1-L15, and one or more core dielectric regions, such as a core dielectric layer positioned at a central portion of the multilayer printed circuit board structure. The multilayer printed circuit board structure may further include a plurality of conductive layers, such as rolled copper layers and reverse-treated foil (RTF) copper layers, interleaved with the plurality of dielectric layers to form a stacked configuration. In example embodiments, the multilayer printed circuit board structure may define a first region corresponding to a beamforming portion of the modular beamforming slices 130 and a second region corresponding to an antenna portion of the modular beamforming slices 130, with a thicker dielectric core region, such as an RO3003 core, disposed between the first region and the second region to support propagation of high-frequency radio frequency signals.

In example embodiments, the multilayer printed circuit board structure may include a plurality of via structures disposed within the plurality of dielectric layers and the plurality of conductive layers, the plurality of via structures including one or more laser vias, microvias, mechanically drilled vias, and through vias. The plurality of via structures may include a first via stack extending between a first set of layers, such as layers L3 through L12, and a second via structure extending between a second set of layers, such as layers L6 through L15, the via structures being configured to provide vertical electrical connections between the beamforming portion and the antenna portion of the modular beamforming slices 130. The multilayer printed circuit board structure may further include intermediate via structures, such as vias extending between adjacent layers or between subsets of layers, the intermediate via structures being configured to distribute signals across the multilayer printed circuit board structure while maintaining controlled impedance and minimizing parasitic effects at high frequencies.

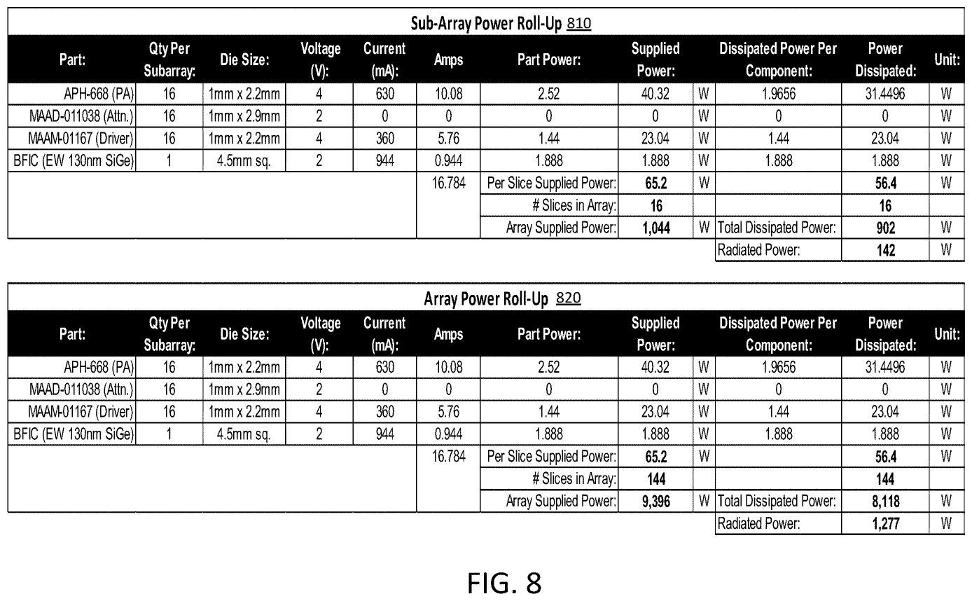

FIG. 8 illustrates a system for characterizing power consumption and power dissipation associated with one or more modular beamforming slices 130 and a corresponding phased array architecture. The system illustrated in FIG. 8 may include a subarray power roll-up 810 and an array power roll-up 820, the subarray power roll-up 810 being configured to represent power characteristics for a subarray including a plurality of modular beamforming slices 130, and the array power roll-up 820 being configured to represent power characteristics aggregated across a full antenna array including a plurality of subarrays. In example embodiments, each of the subarray power roll-up 810 and the array power roll-up 820 may include a plurality of component-level entries corresponding to a power amplifier, a driver amplifier, one or more attenuators, and a beamforming integrated circuit, each component having associated electrical parameters including a voltage, a current, a part power, and a supplied power. The system may be configured to aggregate the electrical parameters across the plurality of components to determine a total supplied power and a total dissipated power for the subarray power roll-up 810 and the array power roll-up 820.

In example embodiments, the subarray power roll-up 810 and the array power roll-up 820 may further be configured to determine a relationship between supplied power, dissipated power, and radiated power for a phased array system operating at V-band frequencies. The subarray power roll-up 810 and the array power roll-up 820 may indicate that a substantial portion of supplied power may be dissipated as thermal energy due to limited efficiency of active components, such as power amplifiers operating at V-band frequencies, thereby contributing to high power density within the modular beamforming slices 130. As a nonlimiting example, a phased array system deployed in a satellite communication system may include a plurality of subarrays, each subarray including multiple modular beamforming slices 130, wherein the array power roll-up 820 may represent an aggregate supplied power of several kilowatts and a corresponding dissipated power that may be removed through one or more thermal transport structures, such as heat pipes integrated within a housing. Such a configuration may enable the system to achieve a high effective isotropic radiated power while addressing thermal management challenges associated with dense element packing and limited component efficiency. In example embodiments, alternative component selections, power levels, and array configurations may be used to support different phased array architectures or operating conditions without departing from the scope of the present disclosure.

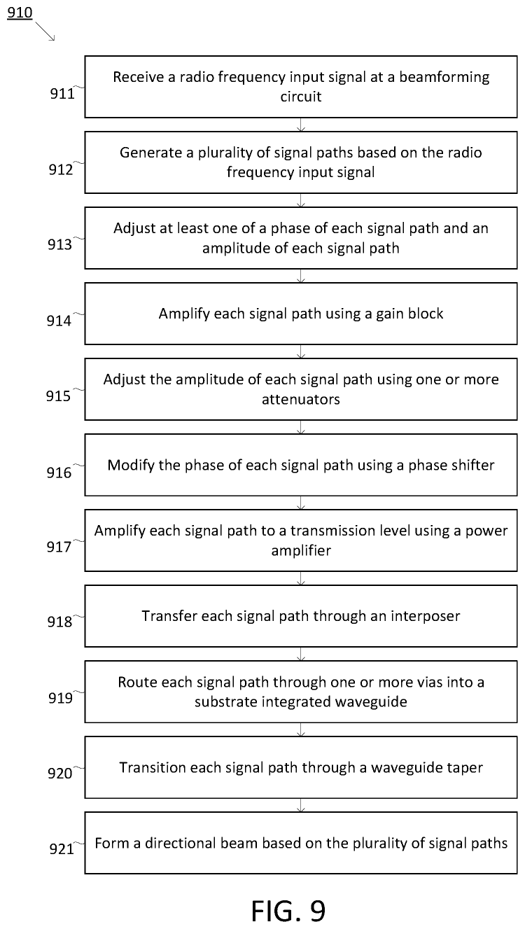

FIG. 9 illustrates a process 910 that may be performed by a system or processor in example embodiments. The process 910 may be configured to generate a high-frequency directional beam using a modular beamforming architecture, such as the modular beamforming slices 130 described herein. The actions illustrated in FIG. 9 may, in other example embodiments, be performed in a different order, omitted, or repeated. The system or processor may receive 911 a radio frequency input signal at a beamforming circuit. In example embodiments, the radio frequency input signal may correspond to an intermediate frequency signal that is subsequently processed for transmission at V-band frequencies. The system or processor may generate 912 a plurality of signal paths based on the radio frequency input signal, the plurality of signal paths corresponding to a plurality of antenna elements included in a modular beamforming slice. The system or processor may adjust 913 at least one of a phase of each signal path and an amplitude of each signal path, such that a desired phase and amplitude distribution is established across the plurality of signal paths to support beam steering and beam shaping operations.

The system or processor may amplify 914 each signal path using a gain block. The system or processor may adjust 915 an amplitude of each signal path using one or more attenuators. The system or processor may modify 916 a phase of each signal path using a phase shifter, such that a relative phase difference between signal paths may be controlled to define a beam direction. The system or processor may amplify 917 each signal path to a transmission level using a power amplifier. In example embodiments, the gain block, the one or more attenuators, the phase shifter, and the power amplifier may be arranged in a series signal chain within the modular beamforming slice, the series signal chain being configured to provide sufficient gain and phase control while maintaining linearity for high-throughput modulation schemes. Such a configuration may address limitations associated with available components at V-band frequencies, including limited output power and reduced efficiency.

The system or processor may transfer 918 each signal path through a silicon carbide interposer, the silicon carbide interposer being configured to provide a low-loss transition from the power amplifier to a printed circuit board structure. The system or processor may route 919 each signal path through one or more vias into a substrate integrated waveguide formed within a multilayer printed circuit board, such as the multilayer printed circuit board structure described with respect to FIG. 6-7. In example embodiments, the vias and the substrate integrated waveguide may provide a vertically integrated signal path that reduces parasitic losses relative to conventional interconnect structures while enabling dense element packing. At block 920, the system or processor may transition 920 each signal path through a waveguide taper, the waveguide taper being configured to increase an effective aperture size and improve radiation efficiency, including suppression of grating lobes through a transition to an electrically larger aperture. The system or processor may form 921 a directional beam based on the plurality of signal paths radiated by a plurality of radiating elements, the directional beam being controlled based at least in part on the phase and amplitude adjustments.

Various embodiments may be described in the following clauses:
1. A system comprising:
a phased antenna subarray comprising a plurality of modular beamforming slices disposed in a housing;
a backplane operably coupled to the plurality of modular beamforming slices;
an antenna control unit operably coupled to the backplane and to provide control signals for the plurality of modular beamforming slices, wherein the control signals are to operate at millimeter-wave frequencies in a V-band range; and
a plurality of heat diffusion elements to diffuse heat from the plurality of modular beamforming slices.
2. The system of clause 1, wherein the V-band range is approximately 70 GHz to 75 GHz.
3. The system of clause 1, wherein individual ones of the plurality of modular beamforming slices include sixteen signal chains corresponding to sixteen radiating elements.
4. The system of clause 1, wherein the phased antenna subarray comprises sixteen modular beamforming slices and includes a 16 ×16 arrangement of radiating elements.
5. The system of clause 1, wherein the plurality of heat diffusion elements comprises at least one heat pipe disposed adjacent to the plurality of modular beamforming slices to diffuse heat from active components.
6. The system of clause 1, wherein individual ones of the plurality of modular beamforming slices comprise:
a beamforming circuit configured to receive at least one radio frequency input and generate a plurality of output signals;
for each output signal, a corresponding signal chain including a gain block, at least one attenuator, a phase shifter, and a power amplifier;
a silicon carbide interposer coupled to an output of the power amplifier;
at least one via coupled to the silicon carbide interposer;
a substrate integrated waveguide formed in a printed circuit board and coupled to the at least one via;
a waveguide taper coupled to the substrate integrated waveguide; and
a radiating element coupled to the waveguide taper,
wherein the antenna control unit is configured to control phase and amplitude across the plurality of output signals to form a directional beam.
7. The system of clause 6, wherein the silicon carbide interposer provides a transition that launches directly into the substrate integrated waveguide through the at least one via.
8. The system of clause 6, wherein the waveguide taper comprises a stepped transition that expands an effective aperture of the substrate integrated waveguide to increase gain and suppress grating lobes.
9. The system of clause 6, wherein the phased antenna subarray is configurable as a direct radiating array or as a phased array-fed reflector feed.
10. A method comprising:
receiving a radio frequency input signal at a beamforming circuit of a modular beamforming slice in a phased array antenna;
generating a plurality of signal paths based on the radio frequency input signal;
adjusting at least one of a phase and an amplitude of each of the plurality of signal paths;
amplifying each of the plurality of signal paths using at least one amplifier stage including a power amplifier;
transferring each amplified signal path through an interposer;
routing each amplified signal path through at least one via into a substrate integrated waveguide (SIW) formed in a circuit board;
transitioning each amplified signal path through a waveguide taper; and
radiating the transitioned signal paths by a plurality of radiating elements to form a directional beam.
11. The method of clause 10, wherein the phased array antenna is operated in a V-band frequency range.
12. The method of clause 11, wherein the V-band frequency range is approximately 70 GHz to 75 GHz.
13. The method of clause 10, wherein transferring each amplified signal path through the interposer comprises transferring each amplified signal path through a silicon carbide interposer coupled to an output of a corresponding power amplifier.
14. The method of clause 10, wherein transitioning each amplified signal path through the waveguide taper comprises performing a stepped expansion from the substrate integrated waveguide to an enlarged radiating aperture.
15. The method of clause 10, further comprising conducting heat away from the modular beamforming slice using at least one thermal transport structure including a heat pipe.
16. A V-band phased array beamforming apparatus comprising one or more processors to provide control signals to a plurality of modular beamforming slices of a phased array antenna to control phase and amplitude of radio frequency signals applied to a plurality of radiating elements, wherein the control signals comprise millimeter-wave frequencies in a V-band range.
17. The V-band phased array beamforming apparatus of clause 16, wherein the V-band range is approximately 70 GHz to 75 GHz.
18. The V-band phased array beamforming apparatus of clause 16, wherein the control signals include control for at least one attenuator and at least one phase shifter in each modular beamforming slice.
19. The V-band phased array beamforming apparatus of clause 16, wherein the one or more processors are to control an antenna control unit coupled to a backplane, the backplane to distribute the control signals to the plurality of modular beamforming slices.
20. The V-band phased array beamforming apparatus of clause 16, wherein the phased array antenna is configurable as a direct radiating array or as a phased array-fed reflector feed.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit disclosure to a specific form or forms disclosed, but on the contrary, the intention is to cover all modifications, alternative constructions, and equivalents falling within the spirit and scope of disclosure, as defined in the appended claims.

Use of terms “a” and “an” and “the” and similar referents in the context of describing disclosed embodiments (especially in the context of the following claims) is to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein is merely intended to serve as a shorthand method of referring individually to each separate value falling within range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media comprises multiple non-transitory computer-readable storage media, and one or more of the individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium stores instructions and a main central processing unit (“CPU”) executes some of the instructions while a graphics processing unit (“GPU”) executes other instructions. In at least one embodiment, different components of a computer system have separate processors, and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operations such as addition, subtraction, or multiplication. In at least one embodiment, an arithmetic logic unit is used to implement logical operations such as logical AND/OR or XOR. In at least one embodiment, an arithmetic logic unit is stateless and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to the inputs of the arithmetic logic unit. In at least one embodiment, the instruction codes provided by the processor to the ALU are based at least in part on the instruction executed by the processor. In at least one embodiment, combinational logic in the ALU processes the inputs and produces an output that is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein, and such computer systems are configured with applicable hardware and/or software that enable performance of operations. Further, a computer system that implements at least one embodiment of the present disclosure is a single device and, in another embodiment, is a distributed computer system comprising multiple devices that operate differently, such that the distributed computer system performs operations described herein and such that a single device does not perform all operations.

Use of any and all examples, or exemplary language (e.g., “such as”) provided herein, is intended merely to better illuminate embodiments of disclosure and does not pose a limitation on the scope of disclosure unless otherwise claimed. No language in the specification should be construed as indicating any non-claimed element as essential to the practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still cooperate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an interprocess communication mechanism.

Although descriptions herein set forth example implementations of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a phased antenna subarray comprising a plurality of modular beamforming slices disposed in a housing;
a backplane operably coupled to the plurality of modular beamforming slices;
an antenna control unit operably coupled to the backplane and to provide control signals for the plurality of modular beamforming slices, wherein the control signals are to operate at millimeter-wave frequencies in a V-band range; and
a plurality of heat diffusion elements to diffuse heat from the plurality of modular beamforming slices.

2. The system of claim 1, wherein the V-band range is approximately 70 GHz to 75 GHz.

3. The system of claim 1, wherein individual ones of the plurality of modular beamforming slices include sixteen signal chains corresponding to sixteen radiating elements.

4. The system of claim 1, wherein the phased antenna subarray comprises sixteen modular beamforming slices and includes a 16×16 arrangement of radiating elements.

5. The system of claim 1, wherein the plurality of heat diffusion elements comprises at least one heat pipe disposed adjacent to the plurality of modular beamforming slices to diffuse heat from active components.

6. The system of claim 1, wherein individual ones of the plurality of modular beamforming slices comprise:
a beamforming circuit configured to receive at least one radio frequency input and generate a plurality of output signals;
for each output signal, a corresponding signal chain including a gain block, at least one attenuator, a phase shifter, and a power amplifier;
a silicon carbide interposer coupled to an output of the power amplifier;
at least one via coupled to the silicon carbide interposer;
a substrate integrated waveguide formed in a printed circuit board and coupled to the at least one via;
a waveguide taper coupled to the substrate integrated waveguide; and
a radiating element coupled to the waveguide taper,
wherein the antenna control unit is configured to control phase and amplitude across the plurality of output signals to form a directional beam.

7. The system of claim 6, wherein the silicon carbide interposer provides a transition that launches directly into the substrate integrated waveguide through the at least one via.

8. The system of claim 6, wherein the waveguide taper comprises a stepped transition that expands an effective aperture of the substrate integrated waveguide to increase gain and suppress grating lobes.

9. The system of claim 6, wherein the phased antenna subarray is configurable as a direct radiating array or as a phased array-fed reflector feed.

10. A method comprising:
receiving a radio frequency input signal at a beamforming circuit of a modular beamforming slice in a phased array antenna;
generating a plurality of signal paths based on the radio frequency input signal;
adjusting at least one of a phase and an amplitude of each of the plurality of signal paths;
amplifying each of the plurality of signal paths using at least one amplifier stage including a power amplifier;
transferring each amplified signal path through an interposer;
routing each amplified signal path through at least one via into a substrate integrated waveguide (SIW) formed in a circuit board;
transitioning each amplified signal path through a waveguide taper; and
radiating the transitioned signal paths by a plurality of radiating elements to form a directional beam.

11. The method of claim 10, wherein the phased array antenna is operated in a V-band frequency range.

12. The method of claim 11, wherein the V-band frequency range is approximately 70 GHz to 75 GHz.

13. The method of claim 10, wherein transferring each amplified signal path through the interposer comprises transferring each amplified signal path through a silicon carbide interposer coupled to an output of a corresponding power amplifier.

14. The method of claim 10, wherein transitioning each amplified signal path through the waveguide taper comprises performing a stepped expansion from the substrate integrated waveguide to an enlarged radiating aperture.

15. The method of claim 10, further comprising conducting heat away from the modular beamforming slice using at least one thermal transport structure including a heat pipe.

16. A V-band phased array beamforming apparatus comprising one or more processors to provide control signals to a plurality of modular beamforming slices of a phased array antenna to control phase and amplitude of radio frequency signals applied to a plurality of radiating elements, wherein the control signals comprise millimeter-wave frequencies in a V-band range.

17. The V-band phased array beamforming apparatus of claim 16, wherein the V-band range is approximately 70 GHz to 75 GHz.

18. The V-band phased array beamforming apparatus of claim 16, wherein the control signals include control for at least one attenuator and at least one phase shifter in each modular beamforming slice.

19. The V-band phased array beamforming apparatus of claim 16, wherein the one or more processors are to control an antenna control unit coupled to a backplane, the backplane to distribute the control signals to the plurality of modular beamforming slices.

20. The V-band phased array beamforming apparatus of claim 16, wherein the phased array antenna is configurable as a direct radiating array or as a phased array-fed reflector feed.
